(19) United States
(12) Patent Application Publication
(10) Pub. No.: US 2018/0006526 A1
(43) Pub. Date: Jan. 4, 2018

(54) KINETIC ENERGY TO ELECTRICITY SYSTEM AND METHOD

(71) Applicant: Thad Paul Sundrla, Drake, CO (US)

(72) Inventor: Thad Paul Sundrla, Drake, CO (US)

(21) Appl. No.: 15/634,236

(22) Filed: Jun. 27, 2017

Related U.S. Application Data
(60) Provisional application No. 62/357,971, filed on Jul. 2, 2016.

(51) Int. Cl. H02K 7/18; G06Q 50/00; G06Q 30/02

(52) U.S. Cl. CPC H02K 7/1807; H02K 7/1861; G06Q 30/0226; G06Q 50/01

(57) ABSTRACT

A kinetic energy to electricity system and method is disclosed. In an example, the kinetic energy to electricity system includes a kinetic energy generating device. The kinetic energy to electricity system also includes a converter operably associated with the kinetic energy device to convert kinetic energy generated by the kinetic energy device into electricity. The kinetic energy to electricity system also includes a measurement device to measure the generated electricity as feedback units. The feedback units may be implemented in any number of a variety of different ways to encourage use of the system.

### PRIORITY CLAIM

This application claims the priority benefit of U.S. Provisional Patent Application No. 62/357,971 filed Jul. 2, 2016 titled “Kinetic Energy To Electricity System And Method” of Thad Paul Sundrla, hereby incorporated by reference as though fully set forth herein.

### BACKGROUND

The need for electricity continues to grow, as does the significance of social media and its connection to other technologies. Traditional sources of energy, such as building reservoirs, coal-burning, and nuclear power plants are considered environmentally unfriendly. Other sources of energy development are being considered and even becoming mainstream, such as wind and solar power production. The transformation of kinetic energy into electricity has also been explored, but does not yet produce a scalable form of electricity production.

### BRIEF DESCRIPTION OF THE DRAWINGS

FIG. 1 is a high-level illustration of an example kinetic energy to electricity system.

FIG. 2 is a flowchart illustrating an example kinetic energy to electricity method.

FIG. 3 is an illustration of example kinetic energy to electricity system and method implemented with a user monetary reward.

FIG. 4 is an illustration of example kinetic energy to electricity system and method implemented with energy credits via a utility provider.

FIG. 5 is an illustration of example kinetic energy to electricity system and method implemented with sponsor offers.

FIG. 6 is an illustration of example kinetic energy to electricity system and method implemented with social media interaction.

### DETAILED DESCRIPTION

The system and method described herein implement the fitness/health movement to assist in capturing kinetic energy in the form of electricity, getting the generated electricity onto the grid, and implementing credits to help combine the forces of potentially millions (or more) people via social media to create economics of large scale to makes this a viable concept.

Economics of scale are very important to making kinetic energy to electricity a viable concept—both as to the amount of energy being created—and to provide a motivation, e.g., via accumulated credits and social media platforms. While kinetic energy to electricity generation may not make economic sense for an individual effort in terms of the small amount of energy created, the systems and methods described herein when implemented across social media platforms with credits for participating, and with millions of people participating, the systems and methods transform kinetic energy to electricity into a viable concept.

A “green” kinetic energy to electricity system and method are described herein, wherein electricity generated by exercise equipment may be provided onto the power grid and the units of electric power may be measured in “feedback units.” These “feedback units” are transferred to a monetary device (e.g., a debit card capable of converting the feedback units into a monetary equivalent) which can track, store, debit and credit the feedback units in a commercial manner. In an example, Internet social media may be implemented to widely disseminate and globally popularize the process. Energy may also be used as a direct plug-in or for local battery storage, e.g., to recharge electronics such as cell phones. In an example, the system and method herein may be connected via a mobile software application or “app.”

Benefits of the system and method may include, but are not limited to potential income generation, health/exercise, shared group spirit for being a part of a feel-good concept, a green renewable energy source, and a low-cost energy source. Public relations benefits may include, but are not limited to sponsors (e.g., businesses, local government, colleges, etc.) who may provide outfitted equipment at public locations to attract customers. In an example, a business may provide discounts and/or privileges for spending feedback units at that particular business.

It is noted that energy is one of the prime factors for advances in developing countries. As such, the system and method disclosed herein may be of special significance in that respect. Even in developed countries, power supply to remote areas (e.g., mountain, desserts, and other off-grid locations) can benefit from the energy producing and the battery charging features of the system and method disclosed herein, Indeed, such power generation and battery charging aspects may also play a role in connection with power outages as well as remote living areas.

Likewise, fitness and exercise are also important to physical health and mental well-being and becoming increasingly popular in today's society. The system and method disclosed herein promote fitness as well as the growing awareness of health benefits associated with it and combines these with other motivations (e.g., financial and social awareness).

In addition, social media is playing an expanded role today in promoting social and other causes. For example, in addition to the “feel-good” there may be other causes promoted on social media that the system and method may be included with, e.g., such as to raise awareness of energy generation, renewable energy sources, exercising, and fundraising, to name only a few examples. The system and method may also give homeless or low income people an income source, e.g., by generating electricity to pay for food in very low income countries and/or environments.

Before continuing, it is noted that as used herein, the terms “includes” and “including” mean, but is not limited to, “includes” or “including” and “includes at least” or “including at least.” The term “based on” means “based on” and “based at least in part on.”

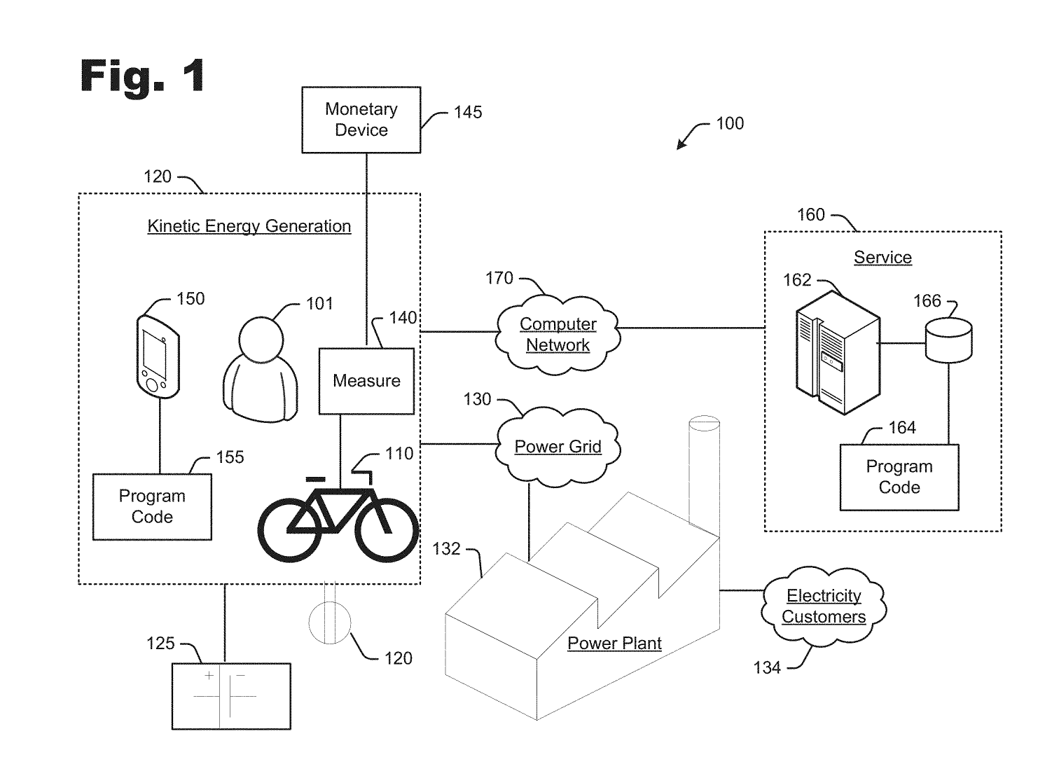

FIG. 1 is a high-level illustration of an example kinetic energy to electricity system 100. The kinetic energy to electricity system 100 may include a kinetic energy generating device, such as a stationary bicycle 110 (stair climber, treadmill) or other device capable of generating kinetic energy when operated by a user 101. The kinetic energy to electricity system 100 also includes a converter operably associated with the kinetic energy device 110 to convert kinetic energy generated by the kinetic energy device into electricity.

In an example, the kinetic energy to electricity system 100 may include an interface (not shown). For example, the interface may connect the converter to an electrical outlet 120 to locally output the generated electricity (e.g., to power home electronics or recharge a mobile phone). Or for example, the interface may connect the converter to a battery 125 to store the generated electricity. In an example, the interface may connect the converter to an electric power grid 130 to transfer the generated electricity to a utility 132 and/or electricity customers 134. Such interfaces are well understood in the electrical generation/storage arts and therefore is not described further herein.

In an example, the kinetic energy to electricity system 100 may include a measurement device 140 to measure the generated electricity as feedback units. For example, a unit of power (e.g., Watts, or KW) may correspond to a predetermined number of feedback unit(s). These feedback units may be issued to a monetary device 145 (e.g., a debit card) to enable the feedback units for use in commerce. The feedback units may be spent directly (e.g., by a participating retailer accepting feedback units) or bought and thus converted to currency for use at any retail establishment.

In an example, the kinetic energy to electricity system 100 may be operable with a computer system, e.g., a mobile phone 150 or other a network device. By way of example, the user 101 may enable an “app” or other program code 155 to connect with a service 160, e.g., via computer network 170 such as the Internet and/or wireless connection. The service 160 may include a server 162 or other computing system executing program code 164 stored on computer-readable storage 166. The service 160 may enable enhancements and features, such as but not limited to promotions, interaction with other users (e.g., to connect in a social media setting).

Before continuing, it should be noted that the examples described above are provided for purposes of illustration, and are not intended to be limiting. Other devices and/or device configurations may be utilized to carry out the operations described herein.

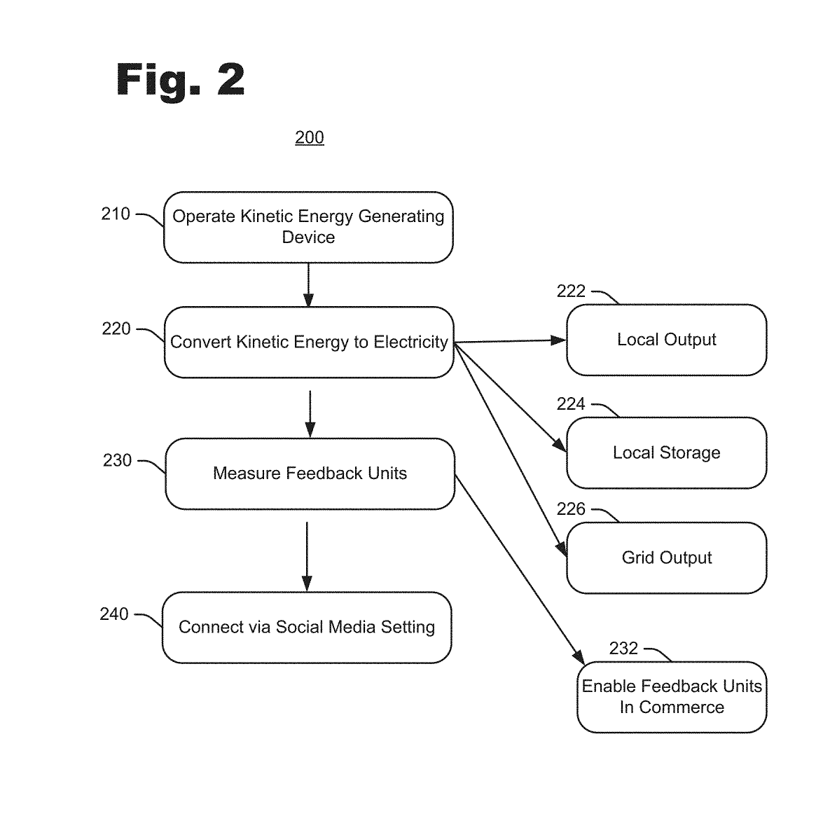

FIG. 2 is a flowchart illustrating an example kinetic energy to electricity method 200.

Operation 210 includes operating a kinetic energy generating device. Operation 220 includes converting kinetic energy of the kinetic energy device into electricity.

Operation 222 further includes locally outputting the generated electricity. Operation 224 further includes storing the generated electricity. Operation 226 further includes transferring the generated electricity onto a power grid.

Operation 230 includes measuring the generated electricity as feedback units. Operation 132 further includes enabling the feedback units in commerce.

Operation 240 includes connecting other users in a social media setting.

The operations shown and described herein are provided to illustrate example implementations. It is noted that the operations are not limited to the ordering shown. Still other operations may also be implemented.

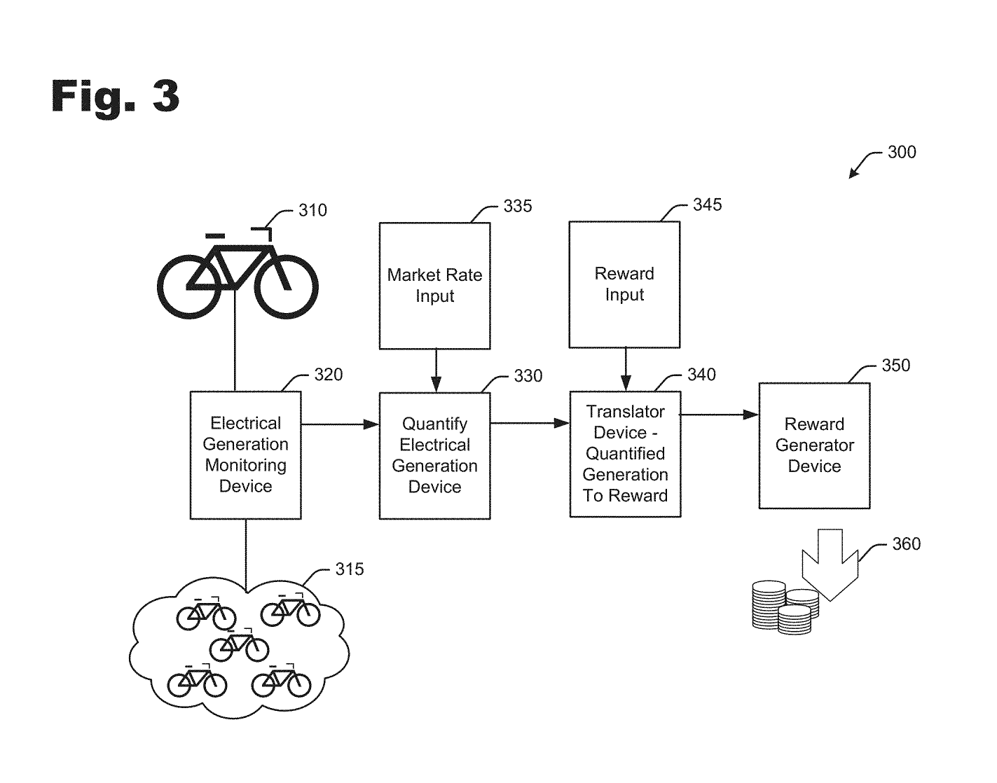

FIG. 3 is an illustration 300 of example kinetic energy to electricity system and method implemented with a user monetary reward.

In an example, a kinetic energy generating device 310 (illustrated as, but not limited to a bicycle) may be implemented by a user to generate kinetic energy via movement. The kinetic energy is converted to electrical energy, e.g., as already discussed above. Kinetic energy may be generated by an individual user, and/or a group of users (e.g., group 315). The group 315 may be local to one another (e.g., within the same gym or other building) and/or dispersed. For example, the group 315 may be virtually connected to one another, albeit geographically remote. The group 315 may be considered a group by way of association (e.g., employees at a company, members of a gym, or connected via social media) even though some or all of the individuals in the group are dispersed geographically (e.g., at separate company campuses, gyms, or residence).

In an example, electrical energy generation is monitored by an electrical generation monitoring device 320. The electrical generation monitoring device 320 may be an electrical circuit which measures electrical generation (e.g., electrical current, charge of a battery, etc.). The electrical generation monitoring device 320 may measure electrical energy generated by individual participant(s) 310 and/or group(s) 315 of participants.

Because market rate input is highly variable, the electrical energy generation may have a different value at different times and under different conditions. As such, the measure of electrical energy is output to a device 330 configured to quantify electrical energy generation. By way of illustration, electrical energy generation may be quantified based on market rate input 335. Market rate input may vary based on a wide variety of factors, such as, but not limited to, the rate charged to customers by a utility company, a wholesale rate, an adjusted rate or supplemented rate (e.g., based on incentives to provide “green” energy), and time-of-day rate (e.g., based on peak demand), to name only a few examples. In an example, the device 330 configured to quantify electrical energy generation may be a processing device and/or electronic circuit which receives input from the electrical generation monitoring device 320, and converts a measured value for the electrical energy generated, into an adjusted value based on market rate input 335.

The adjusted value is input to a translator device 340 to convert the adjusted value of the electrical energy which has been generated, into a quantified reward based on, for example, reward input 345. The reward input 345 may be a monetary reward. The monetary reward may be based on the monetary value of the electrical energy that has been generated. For example, if the electrical energy generated has a resale value of 15 cents per KWh to a utility provider, the reward input may be used to pay the user 3 cents per KWh for electrical energy generated, based, e.g., on any number of factors such but not limited to cost of delivery.

Dispensing the monetary reward may be handled by a reward generator device 350. The reward generator device 350 may be configured to receive input from the translator device 340, and convert the input into a reward 360 for the user. The reward 360 may be a tangible reward (e.g., a gift card or actual cash/coins), or intangible (e.g., a credit to the user's account). In an example, the reward generator device 350 may be a card dispenser (e.g., for dispensing gift cards), a cash/coin dispenser (e.g., for dispensing money), or a computing device specially programmed to credit a user account, bank account, etc.

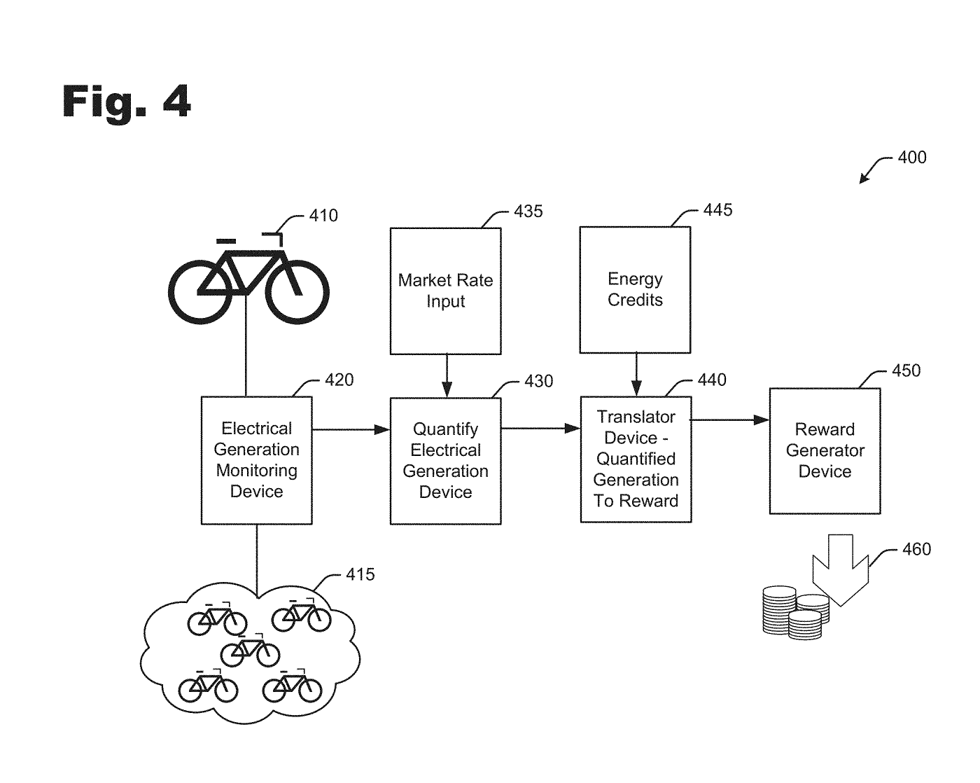

FIG. 4 is an illustration 400 of example kinetic energy to electricity system and method implemented with energy credits via a utility provider. A utility provider may include a public utility company, a “green” provider such as a solar or wind farm, backup power facilities, etc.

In an example, a kinetic energy generating device 410 may be implemented by a user to generate kinetic energy, which is converted to electrical energy. Again, kinetic energy may be generated by an individual user, and/or a group of users (e.g., group 415).

In an example, electrical energy generation is monitored by an electrical generation monitoring device 420, such as, but not limited to an electrical circuit which measures electrical generation (e.g., electrical current, charge of a battery, etc.).

The measure of electrical energy is output to a device 430 configured to quantify electrical energy generation, e.g., based on market rate input 435 already discussed above. The device 430 configured to quantify electrical energy generation may be a processing device and/or electronic circuit which receives input from the electrical generation monitoring device 420, and converts a measured value for the electrical energy generated, into an adjusted value based on market rate input 435.

The adjusted value is input to a translator device 440 to convert the adjusted value of the electrical energy which has been generated, into a quantified reward based on, for example, energy credits 445. Energy credits may be generated based on electrical energy offsets. For example, if 100 KWh of electrical energy is generated, this may offset 100 KWh of usage that the user is not charged for. Of course, the utility company may adjust this value because of the cost of operating the program for the user. So in an example, 100 KWh of generated electricity may only offset 80 KWh of used electricity.

Dispensing the reward may be handled by a reward generator device 450. The reward generator device 450 may be configured to receive input from the translator device 440; and convert the input into a reward 460 for the user. In an example, the reward 460 may be an offset or monetary credit on the user's utility account.

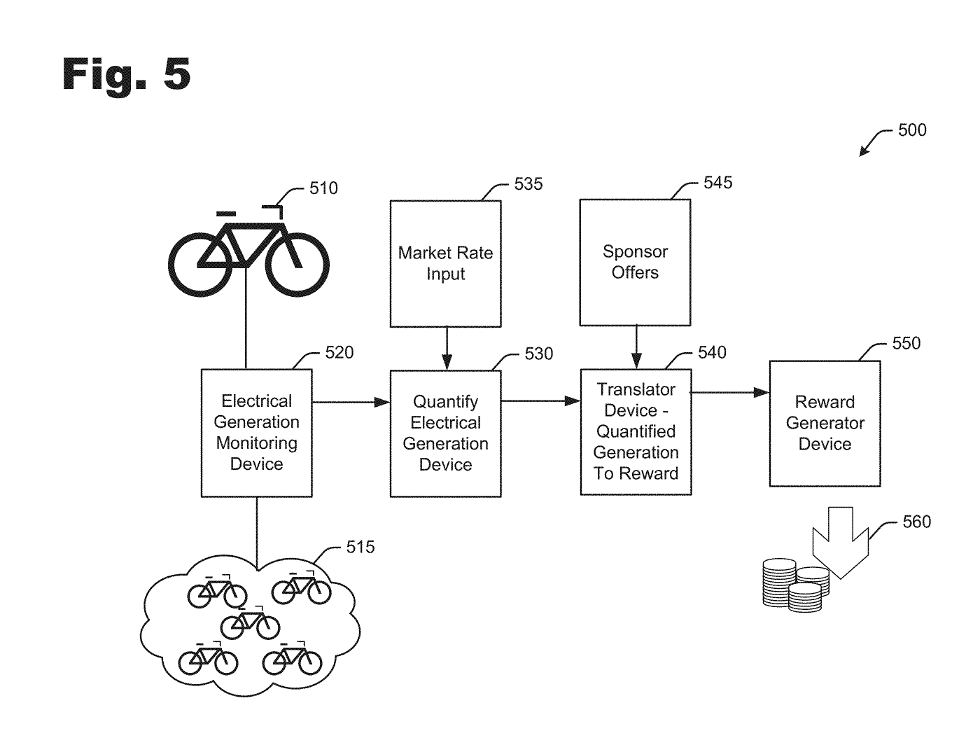

FIG. 5 is an illustration 500 of example kinetic energy to electricity system and method implemented with sponsor offers. Sponsors may include, but are not limited to, businesses, local government, colleges, etc. Public relations benefits for sponsors may include; but are not limited to brand recognition (e.g., by providing outfitted equipment at public locations to attract customers; gift cards; etc.). In an example, the sponsor may provide discounts and/or privileges for spending feedback units at that particular sponsor.

In an example, a kinetic energy generating device 510 may be implemented by a user to generate kinetic energy; which is converted to electrical energy. Again, kinetic energy may be generated by an individual user, and/or a group of users (e.g., group 515).

In an example, electrical energy generation is monitored by an electrical generation monitoring device 520, such as, but not limited to an electrical circuit which measures electrical generation (e.g., electrical current, charge of a battery, etc.).

The measure of electrical energy is output to a device 530 configured to quantify electrical energy generation, e.g., based on market rate input 535 already discussed above. The device 530 configured to quantify electrical energy generation may be a processing device and/or electronic circuit which receives input from the electrical generation monitoring device 520, and converts a measured value for the electrical energy generated, into an adjusted value based on market rate input 535.

The adjusted value is input to a translator device 540 to convert the adjusted value of the electrical energy which has been generated, into a quantified reward based on, for example, sponsor offers 545. Sponsor offers 545 may be provided based on goals of the sponsors. For example, if a business sponsor wants to increase brand awareness, the sponsor offers 545 may be gift cards or coupons for using the business' branded kinetic energy generators and/or facilities. In another example where a college wants its students to only use as much energy as they generate, the sponsor offers 545 may be electrical energy credits. Numerous examples are contemplated and will become readily apparent to those having ordinary skill in the art after becoming familiar with the teachings herein.

Dispensing the reward may be handled by a reward generator device 550. The reward generator device 550 may be configured to receive input from the translator device 540, and convert the input into a reward 560 for the user. The reward 560 may be a tangible reward (e.g., a sponsor gift card), e.g., the reward generator device 550 may be a card dispenser (e.g., for dispensing gift cards). Or the reward 560 may be an intangible reward, such as, but not limited to recognition by the sponsor in the form of a certificate generated by the device 550, special mention in an advertisement, or any of a variety of other types of rewards.

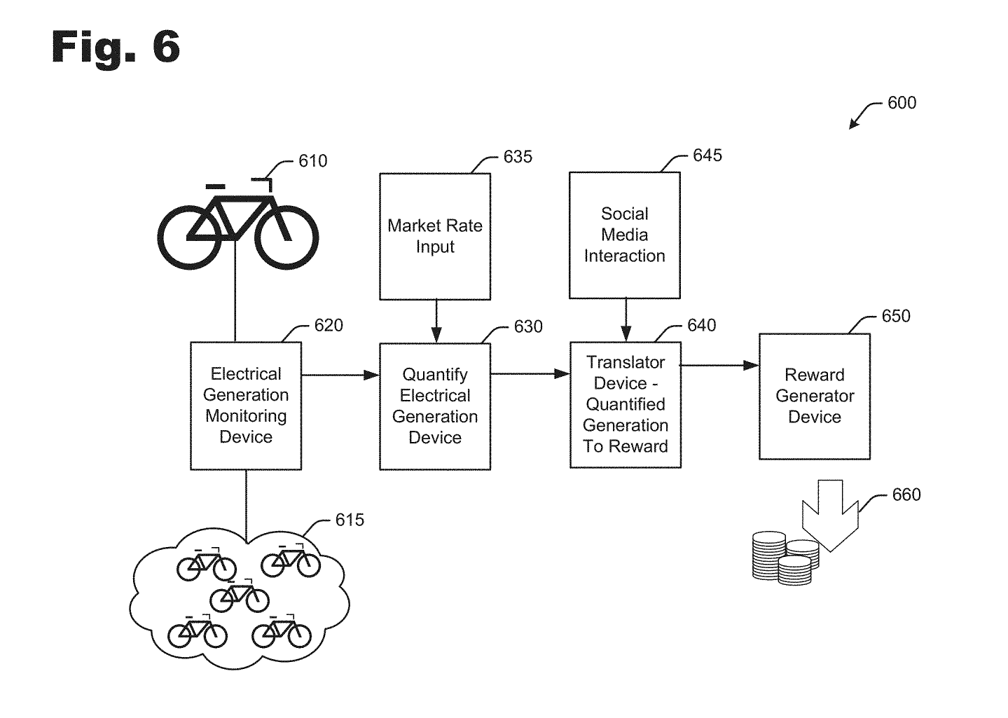

FIG. 6 is an illustration 600 of example kinetic energy to electricity system and method implemented with social media interaction. Social media is playing an expanded role today in promoting social and other causes. For example, in addition to the “feel-good” there may be other causes promoted on social media that the system and method may be included with, e.g., such as to raise awareness of energy generation, renewable energy sources, exercising, and fundraising, to name only a few examples.

In an example, a kinetic energy generating device 610 may be implemented by a user to generate kinetic energy, which is converted to electrical energy, Again, kinetic energy may be generated by an individual user, and/or a group of users (e.g., group 615).

In an example, electrical energy generation is monitored by an electrical generation monitoring device 620, such as, but not limited to an electrical circuit which measures electrical generation (e.g., electrical current, charge of a battery, etc.).

The measure of electrical energy is output to a device 630 configured to quantify electrical energy generation, e.g., based on market rate input 635 already discussed above. The device 630 configured to quantify electrical energy generation may be a processing device and/or electronic circuit which receives input from the electrical generation monitoring device 620, and converts a measured value for the electrical energy generated, into an adjusted value based on market rate input 635.

The adjusted value is input to a translator device 640 to convert the adjusted value of the electrical energy which has been generated, into a quantified reward based on, for example, social media interaction 645. Social media interaction 645 may be include online groups that set goals for generating electrical energy (e.g., for a particular cause). Numerous examples are contemplated and will become readily apparent to those having ordinary skill in the art after becoming familiar with the teachings herein.

Dispensing the reward may be handled by a reward generator device 650. The reward generator device 650 may be configured to receive input from the translator device 640, and convert the input into a reward 660 for the user. The reward 660 may be a tangible reward (e.g., a gift card or prize), e.g., the reward generator device 650 may be a card dispenser (e.g., for dispensing gift cards). Or the reward 660 may be an intangible reward, such as, but not limited to recognition on a social media platform output by the device 650, or any of a variety of other types of rewards.

The example implementations shown and described with reference to FIGS. 3-6 are merely illustrative and not intended to be limiting. Numerous other examples are contemplated and will become readily apparent to those having ordinary skill in the art after becoming familiar with the teachings herein.

It is noted that the examples shown and described are provided for purposes of illustration and are not intended to be limiting. Still other examples are also contemplated.

1. A kinetic energy to electricity system, comprising:
a kinetic energy generating device;
an electrical converter operably associated with the kinetic energy device to convert kinetic energy generated by the kinetic energy device into electricity; and
a measurement device to measure the generated electricity as feedback units.

2. The kinetic energy to electricity system of claim 1, wherein the measurement device further comprises an electrical generation monitoring device to measure electrical energy generated by the kinetic energy generating device.

3. The kinetic energy to electricity system of claim 2, wherein the measurement device further comprises a device to quantify electrical energy generation based on measured input from the electrical generation monitoring device and market rate input.

4. The kinetic energy to electricity system of claim 3, wherein the measurement device further comprises a translator device to convert quantified electrical energy generated by the kinetic energy generating device to a reward based on reward input.

5. The kinetic energy to electricity system of claim 3, wherein the measurement device further comprises a translator device to convert quantified electrical energy generated by the kinetic energy generating device to a reward based on energy credits.

6. The kinetic energy to electricity system of claim 3, wherein the measurement device further comprises a translator device to convert quantified electrical energy generated by the kinetic energy generating device to a reward based on social media interaction.

7. The kinetic energy to electricity system of claim 1, further comprising a reward generator device configured to dispense a reward based on the feedback units.

8. The kinetic energy to electricity system of claim 1, further comprising an interface from the electrical converter to an electrical outlet to locally output the generated electricity.

9. The kinetic energy to electricity system of claim 1, further comprising an interface from the electrical converter to a battery to store the generated electricity.

10. The kinetic energy to electricity system of claim 1, further comprising an interface from the electrical converter to an electric power grid to transfer the generated electricity to a utility provider.

11. The kinetic energy to electricity system of claim 1, further comprising a monetary device to enable the feedback units in commerce.

12. The kinetic energy to electricity system of claim 1, further comprising a network device to connect other users in a social media setting.

13. A kinetic energy to electricity system, comprising:
a kinetic energy generating device;
an electrical converter operably associated with the kinetic energy device to convert kinetic energy generated by the kinetic energy device into electricity;
an electrical generation monitoring device to measure electrical energy generated by the kinetic energy generating device;
a device to quantify electrical energy generation based on measured input from the electrical generation monitoring device and market rate input;
a translator device to convert quantified electrical energy generated by the kinetic energy generating device to a reward; and
a reward generator device configured to dispense a reward based on the feedback units.

14. A kinetic energy to electricity method, comprising:
operating a kinetic energy generating device;
converting kinetic energy of the kinetic energy device into electricity; and
measuring the generated electricity as feedback units.

15. The kinetic energy to electricity method of claim 14, further comprising locally outputting the generated electricity.

16. The kinetic energy to electricity method of claim 14, further comprising storing the generated electricity.

17. The kinetic energy to electricity method of claim 14, further comprising transferring the generated electricity onto a power grid.

18. The kinetic energy to electricity method of claim 14, further comprising enabling the feedback units in commerce.

19. The kinetic energy to electricity method of claim 14, further comprising connecting other users in a social media setting.

20. The kinetic energy to electricity method of claim 14, further comprising wirelessly connecting a user to manage their feedback units.
